(19) United States
(12) Patent Application Publication
(10) Pub. No.: US 2012/0048593 A1
(43) Pub. Date: Mar. 1, 2012

(54) Looped wire elastomeric contactor

(75) Inventor: James V. Russell, Whitehouse Station, NJ (US)

(73) Assignee: R&D Circuits, Inc., South Plainfield, NJ (US)

(21) Appl. No.: 13/136,361

(22) Filed: Jul. 29, 2011

Related U.S. Application Data
(60) Provisional application No. 61/401,027, filed on Aug. 6, 2010.

(51) Int. Cl. H01B 5/00; H01R 43/00

(52) U.S. Cl. 174/126.1; 29/825

(57) ABSTRACT

A looped conductive wire or alternatively a conductive material such as a conductive foil is electrically connected with elastomeric material to provide electrical connections with one or more electronic devices.

### RELATED APPLICATIONS

This is a nonprovisional application of a provisional application Ser. No. 61/401,027 by James V. Russell filed Aug. 6, 2010.

### BACKGROUND

1. Field

The present invention relates to a method and structure for attaching both ends of one or more conductive wires to the same pad of a printed circuit board forming a loop or loops around either a conductive or non-conductive elastomeric material for providing electrical connections between electronic devices. An electrical connector using looped wire or wires around a conductive or nonconductive elastomer on one or both sides of a modified printed circuit (PC) board ensures good electrical contact with lower inductance. The present invention provides for a looped conductive wire to be electrically connected to a PC board pad or pads around an elastomeric material to provide for good conduction and in particular for use in connecting two electronic components.

2. Related Art

U.S. Pat. No. 5,304,460 to Fulton et al. (the '460 patent) relates to an anisotropic conductor in which anisotropic conductors are used to make conductive interconnections to small electronic devices such as semiconductor chips.

U.S. Pat. No. 6,704,985 to Weiss et al. (the '985 patent) relates to an electrical connector using a conductive elastomer provided in sheet form that conducts electricity in the z axis on a consistent pitch over the entire surface of the conducting region. The device in the '985 patent suffers from high contact resistance and poor reliability and these conditions are further exacerbated with temperature.

In both the '460 patent and the '985 patent the conductive pathways pass through the elastomeric matrix of the structure. Further both the '460 and the '587 patents require that the elastomeric material in their respective devices be filled with conductive particles for conductivity purposes.

It would be desirable to provide for a simple effective solution for providing for an elastomeric conductor that avoids the limitations of the aforementioned prior art references.

### SUMMARY

The present invention provides a method and a structure for providing a conductive wire contactor for an elastomeric conductor that is a low inductive, compliant contactor formed of a looped conductive wire that in one embodiment may be attached to both ends of conductive pads and encapsulated within a complaint elastomer. In another embodiment, the looped conductive wire would be formed outside of the compliant elastomer and be attached to both ends of the conductive pads. The wire may be in direct contact with the outside of the elastomer or in yet another embodiment be in contact with a conductive metallic material placed around the elastomer such as a metal foil sheet with a high conductivity and high malleability to ensure that the looped wire does not become deeply embedded into the elastomer. This conductive sheet may or may not be electrically attached to the conductive pads. The looped wires may be over lapping to form a braid. This braid has the effect of increasing the surface area and reducing the skin effect resistance. Further the looped wire may be square, rectangular or of a diamond shape to create sharp edges to help pierce oxides.

### BRIEF DESCRIPTION OF THE DRAWINGS

FIG. 1 illustrates a first embodiment of the present invention in which a looped wire is attached to both ends of conductive pads and encapsulated in a compliant elastomer;

FIG. 2 shows a second embodiment of the present invention in which a looped wire is attached to both ends of conductive pads and forms a loop around the compliant elastomer;

FIGS. 3A and 3B and 3C show top views of the embodiment of FIG. 2 wherein FIGS. 3A, 3B & 3D illustrate an overlapping view of wires and in FIG. 3C the structure's wires are non-overlapping;

FIG. 4 shows another embodiment of the present invention in which instead of wire loops there is a sheet foil covering the elastomer and the sheet foil is bonded to the pads around the base of the elastomer. This structure may or may not have formed ridges where such ridges serve to make sharp points in the foil for lower contact resistance. The foil may be formed separately then placed over the elastomer and bonded to the pad at its base or may be formed over the elastomer and onto the pads through sputter coating, electroless or electrolytic plating;

FIG. 5 is a top view of the embodiment of FIG. 4 in which a foil is bonded over the elastomer.

### DETAILED DESCRIPTION OF THE PREFERRED EMBODIMENT(S)

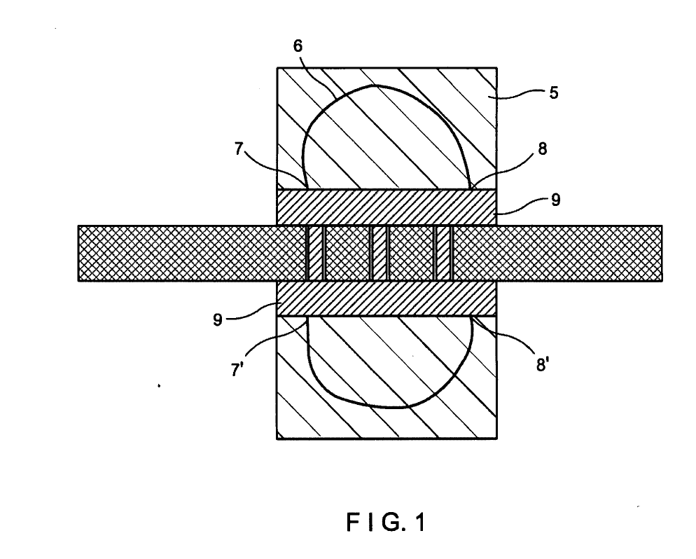

Referring now to the drawings of FIGS. 1-5, FIG. 1 shows a first non-limiting exemplary embodiment of the present invention in which an elastomer 5 has a conductive wire 6 that is shaped in a loop 6 and encapsulated inside the elastomer 5. The loop wire 6 is attached at two ends 7, 8 to pads 9 contacting the substrate as shown in FIG. 1. The looped wire 6 serves as a conductive, complaint contactor for the elastomer or elastomeric material 5 which may or may not be filed with conductive particles.

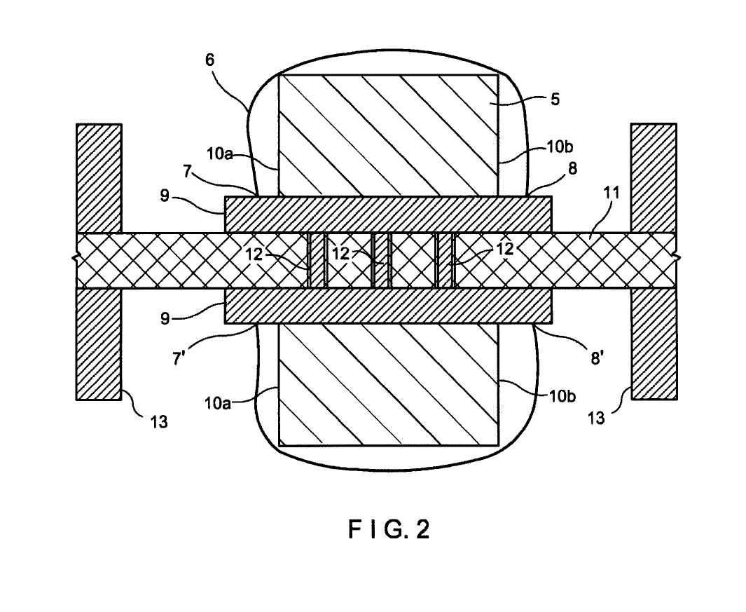

FIG. 2 shows a second non-limiting exemplary embodiment of the present invention. In this embodiment, the looped wire 6 is attached to both ends 7, 8 of conductive pads 9 and loops around the elastomer 5. The loop wire 6 attaches to both ends 7, 8 of the pads 9 at points 7, 8 outside of and away from the sides 10a, 10b of the elastomer 5. Pads 9 connect with the substrate 11 through which vias 12 are located under or around the elastomer. Again the elastomer 5 may or may not be filed with conductive particles or wires. Further, there may be a material bonded to the modified PCB substrate 11 around the pads 9 to provide for a compression stop 13 as to not prevent over compression and thereby prevent damage to the elastomer 5 and looped wire connections.

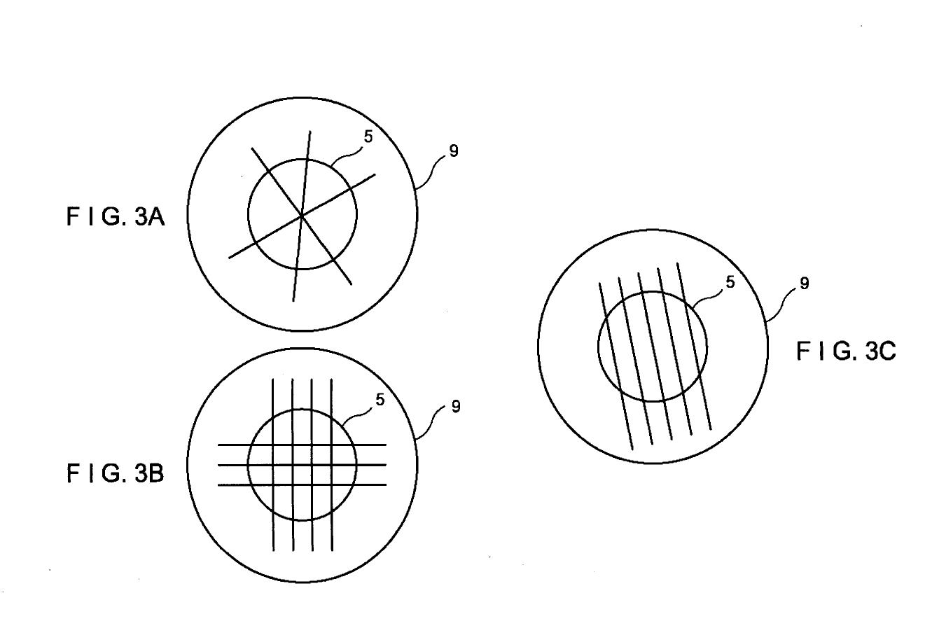

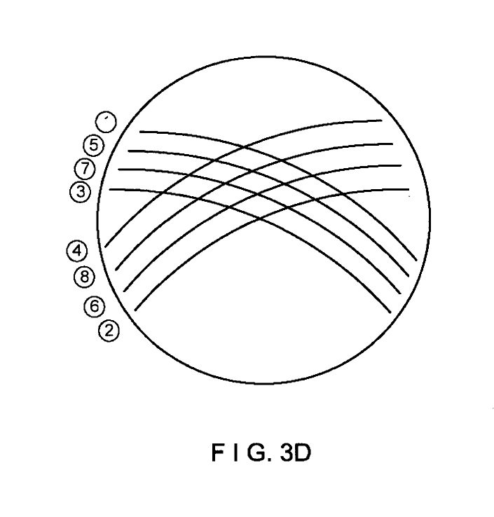

FIGS. 3A, 3B and 3D show a top view of FIG. 2 where overlapping of the looped wires 6 occurs. FIG. 3C shows a non overlapping version of this embodiment. FIG. 3D shows an overlapping version forming a braid with wires numbered 1 through 8.

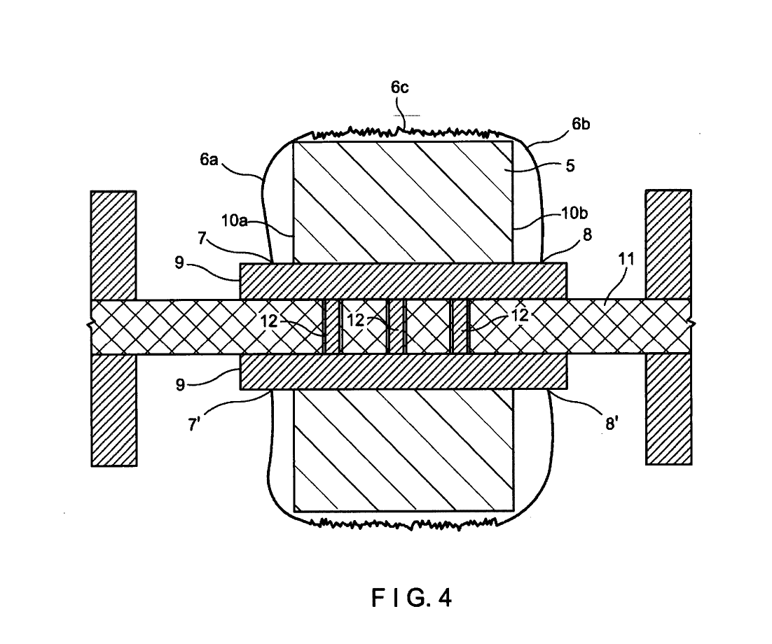

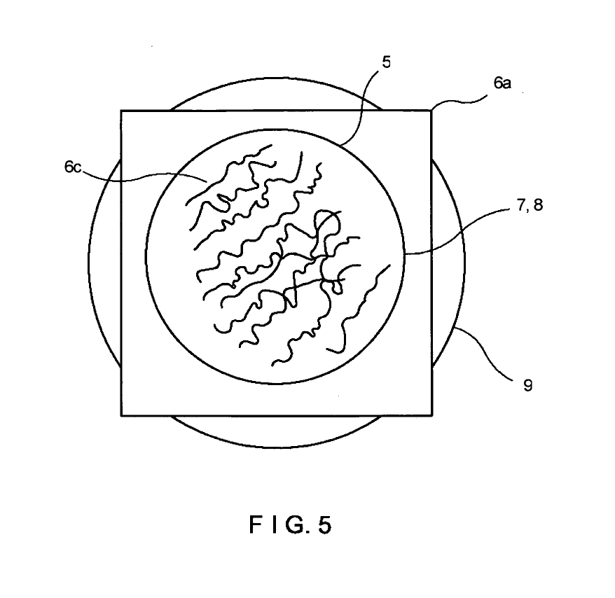

FIG. 4 shows a third non-limiting exemplary embodiment of the present invention in which a metal foil 6a is placed over the elastomer 5. The foil 6a has a high conductivity and high malleability and may be preferably made of gold. The top 6b of the foil 6a may have formed sharp ridges 6c for piercing oxides, oils or debris that may be on the matting contact and will have the effect of lowering contact resistance. Again, the sheet foil 6a attaches to both ends 7, 8 of the pad 9 blanketing the elastomer 5. Pads 9 connect with the substrate 11 through which vias 12 are located under or around the elastomer 5. The elastomer 5 may or may not be filled with conductive particles. FIG. 5 shows a top view of this embodiment. Alternatively, the metal foil or film 6a can be applied directly to the outside of the elastomer 5 and on to the pad 9 through sputter coating, electrolysis or electrolytic plating or by any known method in the art. Further, there may be a material bonded to the modified PCB substrate 11 around the pads 9 to provide for a compression stop 13 as to not allow over compression and thereby prevent damage to the elastomer 5 and metal foil 6a connections.

While presently preferred embodiments have been described for purposes of the disclosure, it is understood that numerous changes in the arrangement of apparatus parts can be made by those skilled in the art. Such changes are encompassed within the spirit of the invention as defined by the appended claims.

1. A method of providing a conductive wire contactor for one or more electronic devices, the steps comprising:
looping a conductive wire and attaching said wire to both ends of conductive pads; and
encapsulating said wire in a complaint elastomeric material so as to provide electrical conductivity to one more electrical devices connected thereto.

2. The method according to claim 1 wherein said elastomeric material is not filled with conductive particles.

3. The method according to claim 1 wherein said elastomeric material is filled with conductive particles.

4. A method of providing a conductive wire contactor for one or more electronic devices, the steps comprising:
looping a conductive wire and attaching said wire to both ends of conductive pads; and
placing said wire outside and around a complaint elastomeric material so as to provide electrical conductivity to one more electrical devices connected thereto.

5. The method according to claim 4 further comprising the step of placing a metal foil sheet over said wire so that said wire is not embedded into said elastomeric material.

6. A method of providing a conductive wire contactor for one or more electronic devices, the steps comprising:
placing a conductive material over a complaint elastomeric material and attaching said conductive material to both ends of conductive pads so as to provide electrical conductivity to one or more electrical devices connected thereto.

7. The method according to claim 6 wherein said conductive material is a foil having a high conductivity and high malleability.

8. The method according to claim 6 wherein said conductive material is made of gold foil.

9. The method according to claim 6 wherein said conductive material has a top portion having formed sharp ridges for piecing oxides, oils or debris that may be on a matting contact and thereby lowers resistance.

10. The method according to claim 6 wherein said elastomeric material is not filled with conductive particles.

11. The method according to claim 6 wherein said elastomeric material is filled with conductive particles.

12. A conductive contactor for one or more electronic devices, the steps comprising:
a loop shaped conductive wire attached to both ends of conductive pads; and a complaint elastomeric material in which said looped shaped wire is encapsulated to provide electrical conductivity to one more electrical devices connected thereto.

13. The contactor according to claim 8 wherein said elastomeric material is not filled with conductive particles.

14. The contactor according to claim 8 wherein said elastomeric material is filled with conductive particles.

15. A conductive wire contactor for one or more electronic devices, the steps comprising:
a conductive loop shaped wire attached said wire to both ends of conductive pads; and
said wire being located outside and around a complaint elastomeric material so as to provide electrical conductivity to one more electrical devices connected thereto.

16. A conductive contactor for one or more electronic devices, comprising:
a conductive material placed over a complaint elastomeric material, said conductive material being attached to both ends of conductive pads so as to provide electrical conductivity to one more electrical devices connected thereto.

17. The contactor according to claim 16 wherein said conductive material is a foil having a high conductivity and high malleability.

18. The contactor according to claim 16 wherein said conductive material is made of gold foil.

19. The contactor according to claim 16 wherein said conductive material has a top portion having formed sharp ridges for piecing oxides, oils or debris that may be on a matting contact and thereby reduces an effect of lowering resistance.

20. The contactor according to claim 16 wherein said elastomeric material is not filled with conductive particles.

21. The contactor according to claim 16 wherein said elastoMeric material is filled with conductive particles.
